(19) United States
(12) Patent Application Publication
(10) Pub. No.: US 2015/0097653 A1
(43) Pub. Date: Apr. 9, 2015

(54) DETERMINATION OF PROXIMITY USING A PLURALITY OF TRANSPONDERS

(71) Applicant: Cambridge Silicon Radio Limited, Cambridge (GB)

(72) Inventors: Simon Gibbs, Bury St. Edmunds (GB); Nicolas Graube, Barrington (GB); Ben Tarlow, Cottenham (GB); Murray Jarvis, Stapleford (GB)

(73) Assignee: Cambridge Silicon Radio Limited, Cambrdige (GB)

(21) Appl. No.: 14/046,031

(22) Filed: Oct. 4, 2013

(51) Int. Cl. G06K 7/10

(52) U.S. Cl. CPC G06K 7/10366
USPC 340/10.1

(57) ABSTRACT

Devices and methods of determining a proximity of a receiver to a tag in a predetermined region. A signal characteristic is sensed at the receiver from the tag and an assisting tag. Zones are defined representing proximity of the receiver to each tag. A presence probability vector for the receiver and zones of each tag is estimated based on the signal characteristic. For the assisting tag, a further presence probability vector for the receiver and zones of the tag is estimated, given the presence probability vector for the assisting tag, based on a spatial relationship between the tag and the assisting tag. A combined probable proximity vector for the receiver and zones of the tag are calculated, using the presence probability vector for the tag and the further presence probability vector via a Bayesian network. The proximity of the receiver to the tag is based on the combined vector.

### FIELD OF THE INVENTION

The present invention is directed generally to proximity awareness in three dimensional space, and, more particularly, to systems and methods for estimating proximity in three dimensional space to a transponder based on interactions among a communication device and at least two short-range transponders.

### BACKGROUND OF THE INVENTION

Short-range beacons using technologies such as infrared, ultrasonics, near-field communications (NFC) and Bluetooth® have been used to determine proximity between a mobile listening device and a beacon. In an example system, a beacon transmitter broadcasts a signal containing its identifier (ID) and a mobile device, proximate to the beacon receives the signal and determines the proximity of the mobile device to the beacon based on characteristics of the received signal. The beacon ID may be a Bluetooth® beacon ID transmitted by a first device, for example a mobile telephone, that desirably maintains a close proximate relationship with a second device, for example a Bluetooth headset even when not in use. When these devices are separated, for example because the user has inadvertently left the phone on a restaurant table, the headset may emit an alarm.

### SUMMARY OF THE INVENTION

The present invention is embodied in devices and methods of determining a proximity of a receiver to a tag in a predetermined region. At the receiver, at least one signal characteristic is sensed from each of the tag and an assisting tag proximate to the tag. One or more zones are defined for each of the tag and the assisting tag in the predetermined region, where each zone represents a respective proximity of the receiver to the tag and the assisting tag. For each of the tag and the assisting tag, a presence probability vector is estimated for the receiver and each zone of the corresponding tag, based on the sensed at least one signal characteristic. For the assisting tag, a further presence probability vector is estimated for the receiver and each zone of the tag given the presence probability vector estimated for the assisting tag, based on a predetermined spatial relationship between the tag and the assisting tag. A combined presence probability vector for the receiver and the corresponding zones of the tag is calculated, from the presence probability vector estimated for the tag and the further presence probability vector via a Bayesian network. The proximity of the receiver to the tag is determined based on the combined presence probability vector.

### BRIEF DESCRIPTION OF THE DRAWINGS

The invention may be understood from the following detailed description when read in connection with the accompanying drawing. It is emphasized, according to common practice, that various features of the drawing may not be to scale. On the contrary, the dimensions of the various features may be arbitrarily expanded or reduced for clarity. Moreover, in the drawing, common numerical references are used to represent like features. Included in the drawing are the following figures:

FIG. 1 is a top-view diagram of a system for determining zonal proximity in an indoor environment, according to an embodiment of the present invention;

FIG. 2A is a functional block diagram of a client device shown in FIG. 1, according to an embodiment of the present invention;

FIG. 2B is a functional block diagram of a server shown in FIG. 1, according to an embodiment of the present invention;

FIG. 2C is a functional block diagram of a transponder, according to an embodiment of the present invention;

FIG. 3 is a functional block diagram illustrating various communication modes of the system shown in FIG. 1, according to an embodiment of the present invention;

FIG. 4A is a functional block diagram illustrating a multi-tag zone proximity estimator which incorporates proximity information from at least one neighboring tag, according to an embodiment of the present invention;

FIG. 4B is a functional block diagram of a portion of the zonal proximity estimator shown in FIG. 4A, illustrating incorporation of previous estimates in a current proximity estimate, according to an embodiment of the present invention;

FIG. 5 is a flow chart illustrating a method for estimating a proximity of a receiver to a tag, according to an embodiment of the present invention;

FIGS. 6A-6E are top-view diagrams of example multiple tag arrangements in an indoor environment, illustrating various spatial relationships between the multiple tags, according to embodiments of the present invention; and

FIG. 7 is a top-view diagram of a tag in a mapped environment, illustrating estimation of a zonal probability using a predetermined confidence region, according to an embodiment of the present invention.

### DETAILED DESCRIPTION OF THE INVENTION

With the proliferation of connected mobile devices and sensors, it may be possible to gather information from clients carrying mobile devices in a proximity aware indoor area and further provide the clients with relevant information related to the area. To date, presence of indoor proximity awareness is limited to, for example, store front door or check out stands. Furthermore, dense and expensive infrastructures may be required, for example, WiFi Access Points, video cameras, in order to establish proximity aware systems which may further need manual intervention by the client, such as, “check-ins”, in order to communicate with the system. Thus, indoor proximity awareness continues to be a challenge as current navigation and positioning systems are optimized for outdoors.

Embodiments of the invention overcome the limitations by defining proximity zones in a region (such as a three-dimensional (3D) volume, a two-dimensional (2D) area, etc.) associated with short range communication devices such as radio frequency (RF) transponders and mobile devices and by associating this space with definitions according to which actions may be taken by the client in possession of the mobile device or client device.

An example proximity system according to the subject invention employs a plurality of transponders (also referred to herein as tags). Each transponder may transmit or receive a signal to or from a client device. Each transponder may be associated with a region of interest. A region of interest may be a particular region of an area covered by the transponders, for example, a portion of a shelving unit in a retail store. The transponder associated with the region of interest may be used to define one or more zones. Zones are defined relative to one or more of the transponders, as described below. Signaling between the client device and the transponder(s) may establish at least a probability of the client device being in a particular zone relative to the transponder. Each of the zones may be considered to be a range of locations relative to each transponder indicating, for example, respectively different levels of proximity between the client device and the region of interest in the covered area.

The system may also associate one or more actions with each of the zones of each of the transponders and may also associate conditions that trigger the actions. For example, in order to allow the user sufficient time to consider a promotional offer, it may be desirable for a condition to trigger an action presenting the offer as the client device approaches the zone corresponding to the promoted product. This may be, for example, an adjacent or nearby zone. Such a condition may also include sensed data on the client's speed and direction.

The proximity of the client device to a particular zone may be determined independently for each transponder. However, there may be information available from other transponders in the vicinity of a transponder of interest that may be useful in estimating the proximity of the client device to a particular zone. In contrast, a single independent assessment of proximity on a transponder by transponder basis may not be aware of any inter-transponder relationships.

The embodiments described below relate to proximity systems and methods of determining a proximity of a receiver device to a transponder of interest. An example proximity system incorporates proximity information associated with multiple transponders in the vicinity of a transponder of interest in order to refine the proximity estimation for the transponder of interest. Additionally, in the presence of a positioning system, the proximity may be refined. To incorporate data associated with additional transponders into the process of inferring proximity of the receiver device to a particular transponder, spatial relationships between the zones for one or more “assisting” transponders (also referred to herein as assisting tags) and those of the transponder of interest (also referred to herein as a test tag) are used. The spatial relationships may be used to estimate a presence probability vector for the receiver device in zones of the test tag conditioned on presence probability vectors for the assisting tags.

This information, and the presence probability vectors for each of the individual tags may each contribute to a Bayesian data fusion process of a Bayesian network. The data fusion output may be the same in form as that from the presence probability vector associated with the test tag. However, the output from the fusion process may have an increased estimation accuracy, having been constructed with the additional supporting evidence that comes from assisting tags and their spatial relationships to the test tag.

Accordingly, by incorporating information from multiple tags, the zone estimation output from a single tag may be improved. Improved performance of the overall zoning system may be desirable in retail markets because false classifications may lead to an unsatisfying user experience and missed opportunities for the retailer.

In contrast to exemplary proximity systems described herein, existing methods either do not use the concept of zones or of geometric relationships among transmitters. Most existing methods output a position relative to local (or global) axes, based on a weighted average of transmitter positions; a set of ranges derived from received signal power or round trip time; or relative distances by measuring time difference of arrival measurements.

The example embodiments are described in terms of short-range transmitters (e.g., Bluetooth® transmitters) the signals from which are captured by mobile client devices, such as a mobile telephone including a Bluetooth transceiver. It is contemplated, however, that other types of transmitters and receivers may be used, for example, infrared (IR), ultrasonic, near-field communications (NFC), etc. In addition, as described further below, the transponders may be RF transceivers that do not broadcast signals but instead, sense signals broadcast by the portable mobile devices. Furthermore, although the transponders are described as being stationary, it is contemplated that they may be mobile devices as well and, thus that the zones defined for these transponders may move throughout the space.

Although the invention is described in terms of a retail environment, it is contemplated that the underlying technology has broader application including, without being limited to, security, enterprise workflow, gaming and social interactions. In short, it may be useful in any environment in which different actions may be triggered based on different levels of proximity among devices.

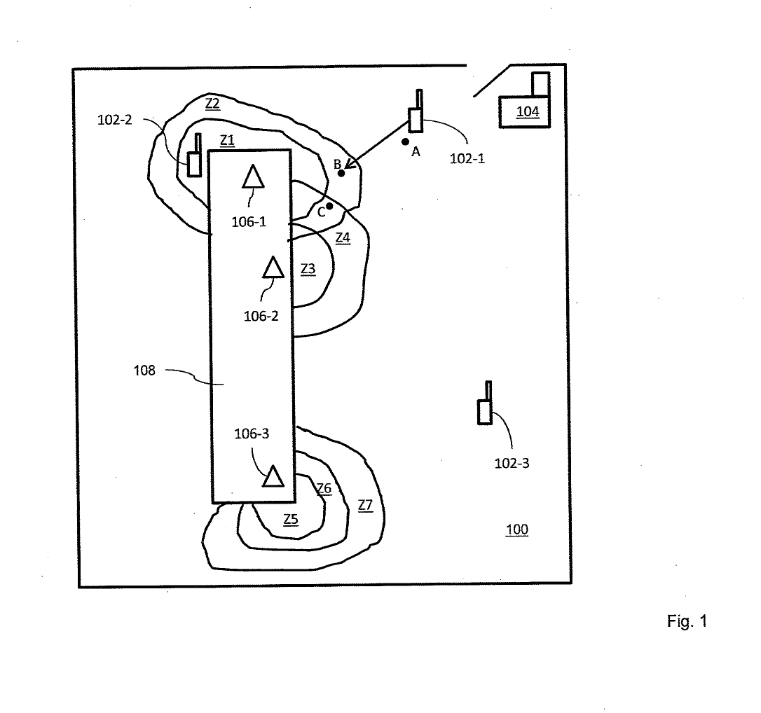

Referring to FIG. 1, a top-view drawing of a portion of a self-serve retail venue 100, such as a grocery store, is shown. Retail venue 100 includes a shelf unit 108 which may hold products (not shown) to be sold. Transponders (also referred to herein as tags) 106-1, 106-2 and 106-3 are coupled to the shelf unit 108 such that their broadcast signals may be sensed by client devices 102. Client devices 102 may determine proximity to a transponder 106 in retail venue 100. One or more zones (e.g., zones Z1-Z7) may be defined relative to transponders 106. Each zone represents a respective proximity of client device 102 to a transponder (such as transponder 106-1). Thus, the proximity may be expressed as a presence within a zone. Client devices 102 may determine the proximity based on signals captured from transponders 106 or may send information on the signals captured from transponders 106 to server 104 which may use the transmitted signals to send zone information to client devices 102. In general, an exemplary multi-tag proximity aware system includes client device 102, a plurality of transponders 106 and server 104.

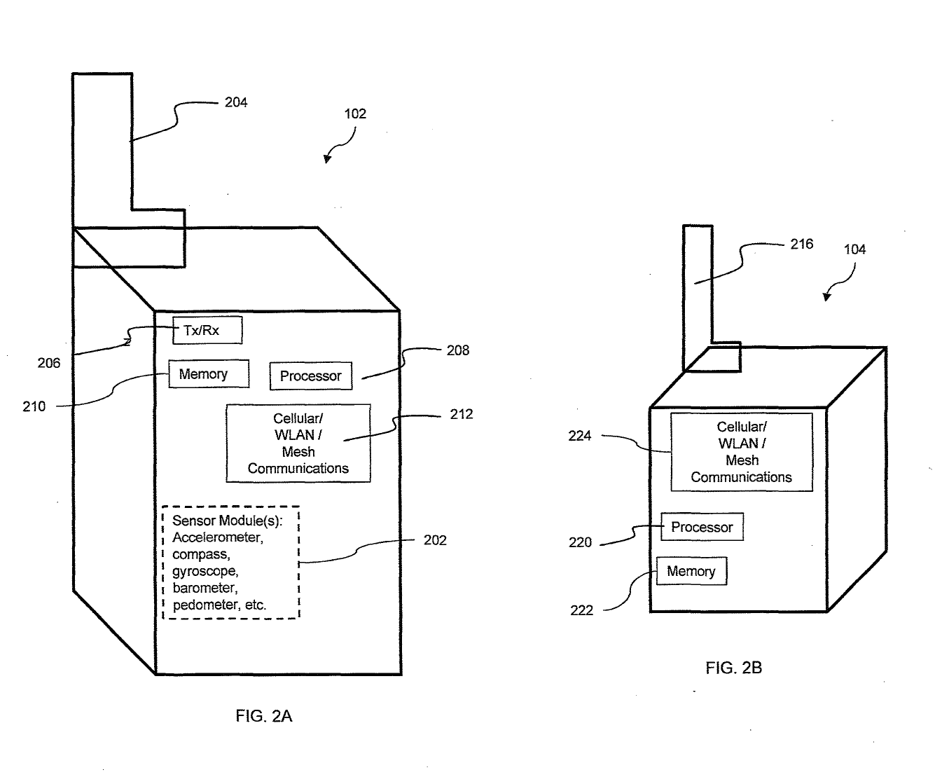

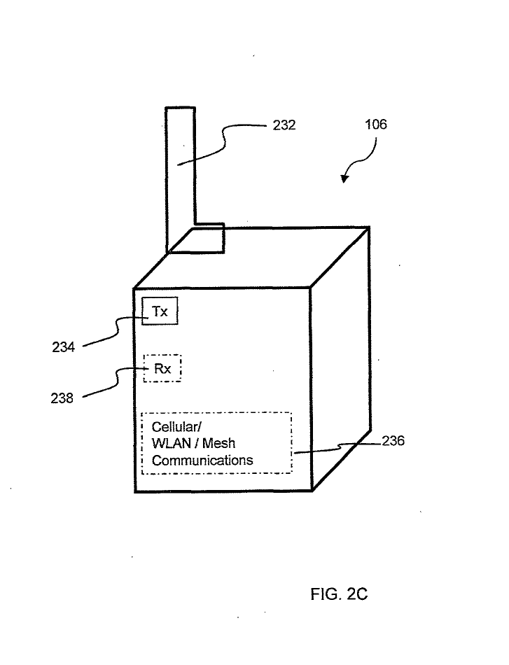

In another embodiment, transponders 106 may be receiving devices that sense signals broadcast by client devices 102 and send identifying information about the respective client device 102 and, optionally, sensed signal strength measurements to server 104 so that server 104 may estimate the zone occupied by client device 102 relative to the transponder 106 (and hence the proximity of client device 102 to transponder 106) from which it received the client's information. The broadcast signals may be radio frequency (RF) or ultrasonic signals or they may be light signals having wavelengths within the infrared (IR), visible or ultra-violet (UV) ranges. Example client, server and transponder devices are described below with reference to FIGS. 2A, 2B and 2C.

Although not shown in FIG. 1, another transponder may be located outside retail venue 100 and may broadcast signals that may be sensed by a client device when it moves outside. Client device 102-3 may be in an area of retail venue 100 where it may be outside the range of transponders 106. Device 102-3 may, however, communicate with the other client devices 102-1 and 102-2, for example via a direct point-to-point communication, in order to exchange information such as zone definitions to reduce the communication burden on the server 104.

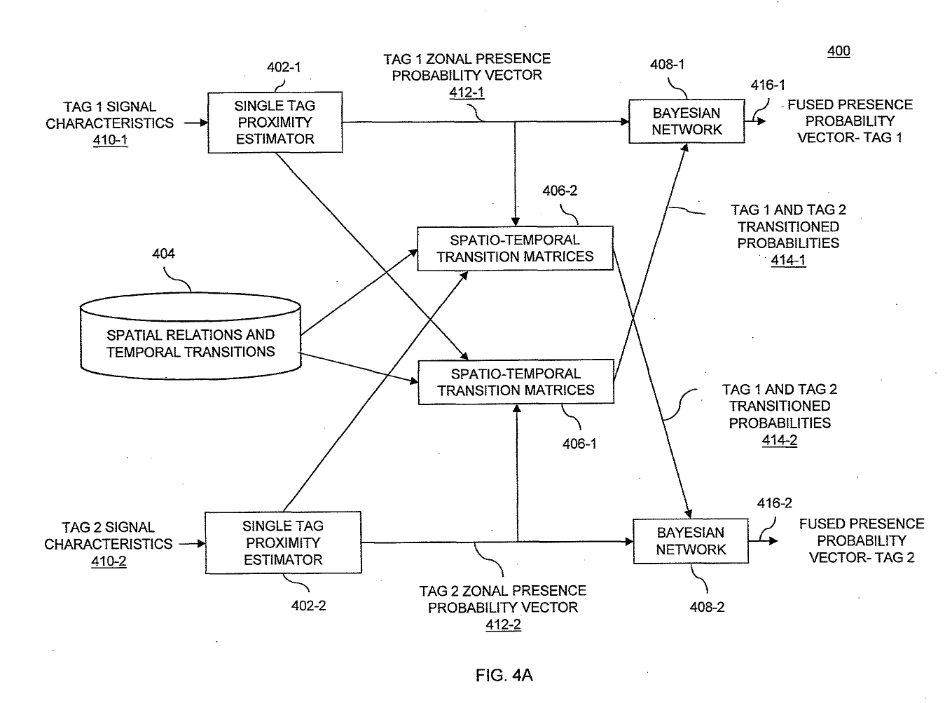

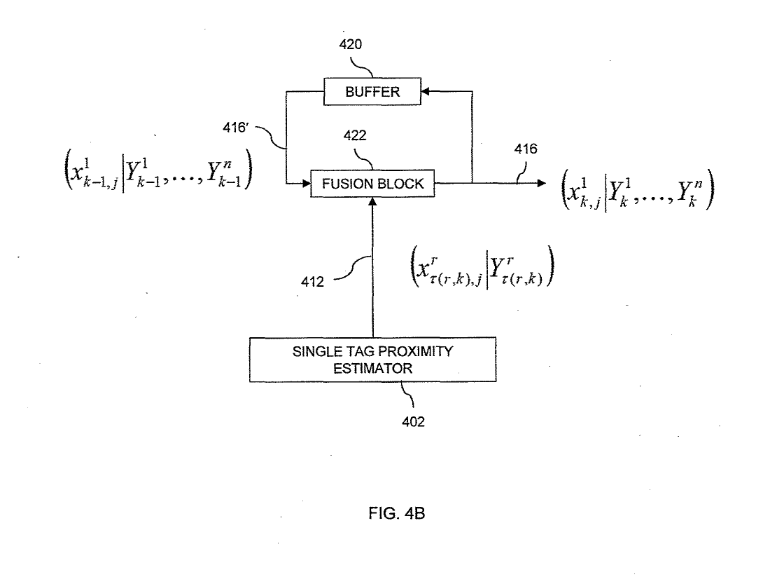

It is contemplated that the determination of the zone proximity may be performed by client device 102, server 104 or a combination thereof. The zone proximity processing may be distributed among client device 102 and server 104. For example, single (individual) tag zonal presence probability vectors (described further below with respect to FIG. 4A), may be determined by client device 102 and server 104 may perform Bayesian fusion processing to determine the zone proximity for the tag of interest using one or more assisting tag zonal presence probability vector. The zonal presence probability vector may indicate the probability that the receiver is in a single zone.

In a server-centric example, the client device 102-1, after entering retail venue 100, transmits information about the sensed signal characteristics of transponders 106-1 and 106-2 to server 104, which may use the information to determine the zone of the client device. For example, client device 102-1 after moving to point B from point A, and communicating the signal characteristics of transponders 106-1 and 106-2 to server 104, may receive information about zone Z2. Client device 102-1 may also communicate with client device 102-2 in order to send and receive information about zone Z1. This operation may repeat as the client device moves from zone to zone. A similar exchange between client device 102-1 and the server 104 may occur when the client device 102-1 moves to point C in zone Z4, for example.

Server-centric systems reduce the computational load on the client device 102 but may greatly increase the communications load in the covered area and, thus, the latency of the zone determination. It is contemplated that the determination of the zones may be performed by client device 102 instead of by server 104. In this embodiment, client device 102 may send only transponder IDs to server 104. Server 104 may respond with definitions for zones associated with the transponder (e.g., transponder 106-1) and with other nearby transponders (e.g., transponder 106-2). These zones may be defined based on proximity to the transponder. Client device 102 may then analyze the sensed transponder signals (including one or more transponder signals for assisting transponders) according to these zone definitions to determine its proximity to the transponder of interest, and, thus, its proximity to a zone. In one embodiment, server 104 may send information on all zones in the covered area to client device 102 which may then store this data in an internal memory. This information may, for example, be conveyed when client device 102 encounters a first transponder, when client device 102 enters the covered area or even before client device 102 enters the area, responsive to a registration process.

The system may also take into account context information related to client device 102 such as, without limitation, its orientation, speed of movement and altitude. In one exemplary embodiment, the context of the client device may be determined using sensors such as, for example, an accelerometer, a pedometer, a compass and an altimeter. It is contemplated that these sensors may be micro-electromechanical sensor (MEMS) devices integral with client device 102.

The analysis may, for example, include comparing the signal characteristics of each of a transponder of interest and at least one assisting transponder to one or more probability distributions to determine, for each transponder, a presence probability vector between client device 102 and each corresponding tag. The analysis may also include incorporating the presence probability vector of the assisting transponder(s) into calculations that produce the presence probability vector of the transponder of interest, based on a predetermined spatial relationship between the transponder of interest and the assisting transponder, forming a combined presence probability vector. The zone (of the transponder of interest) having the highest probability (from the combined presence probability vector) is then selected as an estimate of the proximity of the client device 102 to the transponder of interest.

Referring to FIG. 2A, a functional block diagram of an example client device 102 is shown. Client device 102, which may, for example, be a conventional smart phone, includes receiver (Rx) and/or transmitter (Tx) 206, cellular/WLAN/mesh communications module 212, memory 210, sensor module 202, processor 208 and one or more antennas 204. Receiver 206 senses the low-power signals broadcast by transponders 106 via one of antennas 204. Processor 208 may process the signals sensed by receiver 206 in order to determine the characteristics of the signals and further store these characteristics into memory 210.

For example, the signal characteristics may be further processed by processor 208 to determine the proximity of client device 102 to a transponder of interest. The signal characteristics may be sent to server 104 (FIG. 2B) via communications module 212. Communications module 212, which may include, for example, a IEEE 802.14 Zigbee® transceiver or a Bluetooth transceiver, may communicate with other client devices 102, for example, to share zone information obtained from server 104. Communication between client devices 102 may be implemented using communications module 212, for example using a mesh network, or alternatively, using the short-range communications module 206.

The example client device 102 further includes optional sensor module 202 that may include one or more of an accelerometer, a gyroscope, a compass, a pedometer and/or a barometer. As described above, sensor module 202 may be used to gather information on movement of client device 102. This information may be processed locally by processor 208 or it may be sent to server 104 (FIG. 2B) in addition to signal characteristics for determining zone information and a definition of the zone. In one example, sensor module 202 of client device 102 may also include a camera (not shown) or bar-code scanner (not shown) that a user may employ to scan barcodes or QR codes of the products on shelves 108 (FIG. 1), for example in response to a prompt from client device 102, to assist in generating a definition of the zone.

FIG. 2B is a functional block diagram of an exemplary embodiment of server 104. The example server 104 includes processor 220, memory 222, cellular/WLAN/mesh communications module 224 and one or more antennas 216. The example server 104 is configured to communicate with client devices 102 (FIG. 2A) using communications module 224. For example, server 104 may receive transponder IDs and/or transponder signal characteristics using communication module 224 and processor 220 may process the data to determine zone information and corresponding definition of the zones which may be stored in memory 222. Communications module 224 may also send the stored data to a requesting client device 102 (FIG. 2A). As described above, server 104 may be configured to communicate with transponders 106 (FIG. 2C) via the WLAN communication module 224, for example, which may use one or more antennas 216 to communicate with client devices 102 (FIG. 2B) and/or transponder devices 106 (FIG. 2C).

FIG. 2C is a block diagram of transponder device 106 suitable for use with the subject invention. Transponder device 106 includes transmitter 234, antenna 232, optional receiver 238 and optional cellular WLAN/mesh communications module 236. Antenna 232 may be used for both transmitter 234 and communications module 236, or separate antennas may be used. In one exemplary embodiment, transmitter 234 is a Bluetooth low energy (BLE) transmitter. This device 106 sends signals to client devices 102 (FIG. 2A) that are in the proximity of transponder 106.

In one example, transponder 106 includes only transmitter 234 and antenna 232. Although not shown, transponder 106 also includes a power source, for example, a lithium battery. Because it periodically broadcasts a low-power signal, the example transponder 106 may operate for several years using the battery.

In another example, transponder 106 may include antenna 232 and receiver 238, and may be configured to sense low-power signals (e.g., BLE) signals broadcast by client devices 102 (FIG. 2A) and to send its identity and information on the detected client devices to server 104 (FIG. 2B), for example, via communications module 236.

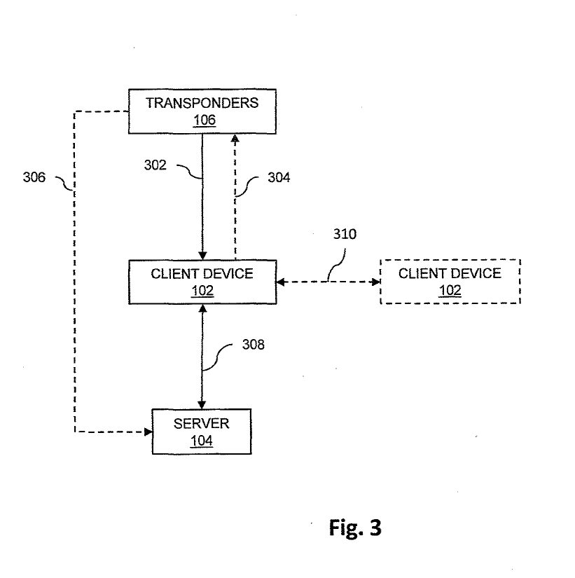

FIG. 3 is a block diagram which is useful for describing the various communications modes of client devices 102, transponders 106 and server 104. In FIG. 3, the solid lines and dashed lines indicate communications among the devices for different embodiments.

In one embodiment (shown by line 302), transponders 106 are transmit-only devices that emit signals having signal characteristics and include a transponder label asynchronously and at regular intervals. These signals are sensed by one or more client devices 102 proximate to transponders 106. Each client device 102 senses signals from transponders 106 that are within range and can collect, none, one or more signal characteristics over a period of time. In addition, client device 102 may receive transponder signal(s) and decode the transponder label from the corresponding transponder signal. For example, with reference to FIG. 2A, client device 102 senses the low-power signals broadcast by transponders 106 via one of antennas 204. Information about the sensed signals, such as received signal strength indication (RSSI), round trip time (RU), time of arrival, quality of signal and signal phase are digitized, for example, by an internal ADC (not shown) and stored into memory 210. In addition, the transponder label is decoded from the received signal. In an exemplary embodiment, the digital values may be analyzed by processor 208 (FIG. 2A) (i.e., compared to zone definitions received from the server 104) to determine the proximity of client device 102 to a transponder 106 of interest.

In another embodiment, as shown by the dashed line 304, transponders 106 may be configured to sense low-power signals (e.g. BLE) signals broadcast by client devices 102 and to send their identities and information on the detected client devices to server 104, for example, as shown by dashed line 306. The information sent may include a client device identifier and characteristics of the sensed signal. Server 104 may then determine the zone corresponding to the transponder ID and client device signal characteristics and also the definitions of the zones. Server 104 may then send the zone information to the identified client device 102, for example as shown by line 308.

Client device 102 may also be configured to have bi-directional communication with server 104 and further transmit signal characteristics, where determination of proximity of the client device to a transponder of interest for a predetermined time may be performed by server 104. During the communication, client device 102 may also receive definitions of the zones from server 104, for example. Alternatively, client device 102 may provide such information to server 104.

As indicated by dashed line 310, a cross client device communication may also take place. In such a scenario, the client devices 102 may communicate information among each other regarding their respective zones and definitions of the zones, for example.

Referring next to FIG. 4A, a functional block diagram of an exemplary multi-tag zone proximity estimator 400 is shown. Estimator 400 incorporates proximity information from a test tag and at least one neighboring tag to determine a proximity of a client device to the test tag. Estimator 400 may include single tag proximity estimator 402, database 404, spatio-temporal transition matrix module 406 and Bayesian network 408. As discussed above with respect to FIG. 1, components of estimator 400 may be included in client device 102 (FIG. 1), server 104 or a combination thereof.

The architecture of estimator 400 is described herein for the case of a deployment space consisting of two mutually cooperating tags (such as tags 106-1, 106-2 in FIG. 1). The architecture may be generalized to any number of tags, although more complexity may be introduced into the predetermined spatial relationships among tags, as will be described below. In general, estimator 400 may use information from any suitable number of assisting tags proximate to a test tag (also referred to herein as a first tag).

According to an exemplary embodiment, when a potentially large number of assisting tags are present, the assisting tags may be grouped into small (non-mutually) exclusive states, to reduce the occupational complexity of the spatial relationships. In this way, each individual (test) tag may be associated with a small number of assisting tags (e.g., its nearest few neighbors).

According to another example, estimator 400 may generate separate proximity estimates (also referred to herein as presence probability vectors) for a number of different sets of assisting tags that are proximate to a test tag. Estimator 400 may then perform an additional Bayesian data fusion of each estimate to obtain a final proximity estimate for the test tag. For example, if there are 9 assisting tags proximate to a test tag, the 9 assisting tags may be divided into 3 sets of assisting tags, with a separate proximity estimate being determined for each set. The three proximity estimates (one for each set) may be applied to Bayesian network 408 to generate a final fused proximity estimate for all of the sets.

In FIG. 4A, for simplicity, single tag proximity estimator 402-r, module 406-r and Bayesian network 408-r are illustrated as being associated with tag r (where r is 1 or 2). In practice, module 406 and Bayesian network 408 may be configured to process information for multiple tags.

Single tag proximity estimator 402-r receives at least one signal characteristic 410-r from tag r and may estimate a zonal presence probability vector 412-r for tag r. The signal characteristic may include, without limitation, at least one of a signal strength, a signal round-trip time, a signal arrival time, a signal quality or a signal phase. Estimator 402-r may also use context information regarding client device 102 (FIG. 1), such as, for example, its orientation, speed of movement and altitude to estimate the zonal presence probability vector 412-r. In general, the signal characteristic(s) may be compared to one or more probability distributions to determine respective probabilities that the client device is proximate to tag r. The probability distributions may be generated by applying empirical measurements to a predetermined distribution or by modeling a frequency distribution generated by multiple measurements. The estimation may be determined through a Bayesian inference process. Motion of the client device 102 may be modeled as a Markov chain and applied to the zonal presence probability vector via a transition matrix. Zonal presence probability vectors and transition matrices are described in U.S. application Ser. No. 13/763,899 to Gibbs et al., entitled “METHOD FOR SHORT-RANGE PROXIMITY DERIVATION AND TRACKING,” the description of which is incorporated herein.

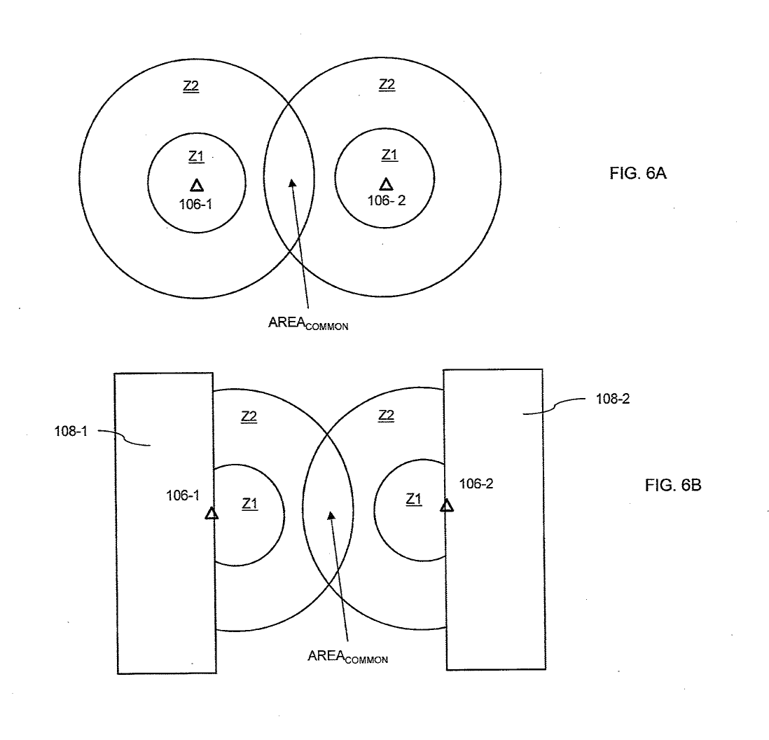

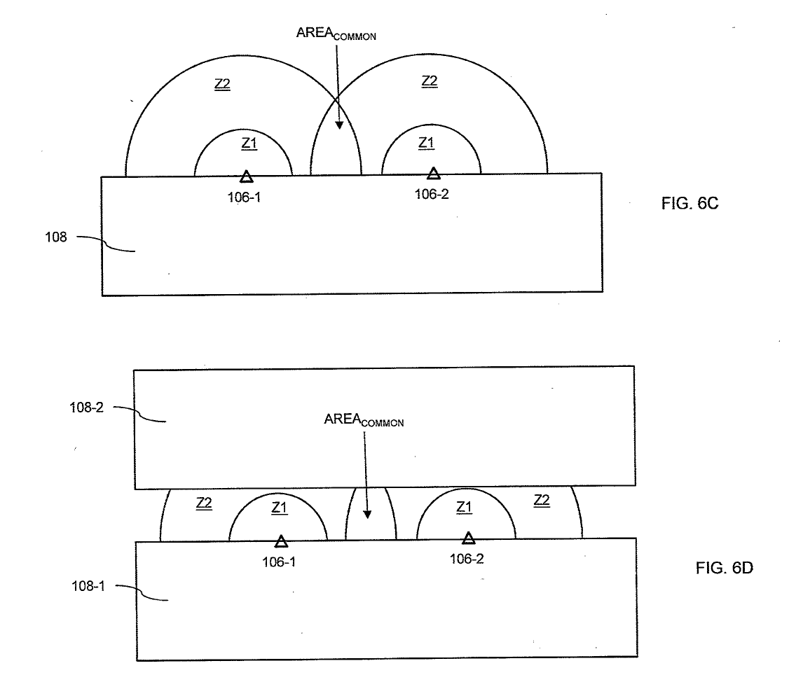

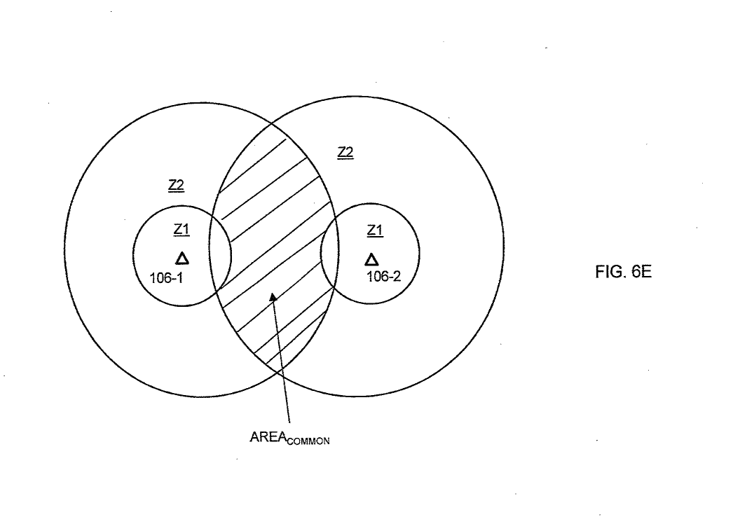

Database 404 may store predetermined spatial relationships between zones associated with different tags. These spatial relationships may be supplied through precise geometrical statements of the areas or volume of intersection between all of the zones of both tags as well as the total area or volume associated with each zone of the assisting tag. Examples of spatial relationships between tags for various tag arrangements are described further below with respect to FIGS. 6A-6E. The predetermined spatial relationships may be applied to zonal presence probability vectors 412 in spatio-temporal transition matrix module 406.

In general, the probability of a location being in zone ‘a’ of the test tag (the first tag), given that it is present in zone ‘b’ of the assisting tag (the second tag) is (assuming uniform probability density within any particular zone), the area lying on both zones (the intersection) divided by the area of zone ‘b’ of the assisting tag. These ideal geometrical statements may take into consideration any regions excluded by the presence of impenetrable obstacles such as shelving. It may be appreciated that looser definitions may be provided for these relationships in some cases, and that the resulting calculation of conditional probabilities (based on zonal intersections between) are commensurately approximate.

Database 404 may also store predetermined temporal transition probability values that may define the probability of moving from any zone in the covered area to any other zone. The transition probability values may be dependent upon a definition of the zones, the duration between updates (from a previous state to a current state) and estimates of the probability distribution for the speed of the motion of the client device 102. The temporal transition probability values may be applied to zonal presence probability vectors 412 in transition matrices of spatio-temporal transition matrix module 406. For example, a transition matrix of a Markov chain may encapsulate estimates of conditional probabilities that client device 102 will move between every possible pair of zones (including no change in zone) from a previous state to a current state.

The problem of fusing the zonal presence probability vector estimates for a pair of tags, focuses first on just one of the pair (e.g., tag 1, i.e., the test tag). At a particular instant, suppose that a column vector of probabilities (whose elements are associated with the zones of tag 1) becomes available as the output of the Hidden Markov Model (HMM) for tag 1. A similar column vector corresponding to the zones of the assisting tag (tag 2) is available from the output of the HMM for tag 2.

One problem in using data from assisting tags is that it is asynchronous with data from the test tag. This may be resolved by the application of the temporal transition matrix. Another problem in using data from assisting tags (e.g., tag 2) is that the assisting tag output refers to probabilities of zonal proximity for tag 2. This may be resolved by the application of conditional probabilities based on the spatial relationships between the zones of the two tags as described herein.

Spatio-temporal transition matrix module 406-r receives a timestamp of the currently estimated zonal presence probability vector (timestamp of (412-r)) for the associated tag r as well as the most recently estimated timestamp and zonal proximity probabilities for the other tag (412, but not r) and applies a temporal transition matrix and spatial relationship matrix to the presence probability vector for the assisting tag (not r).

For example, module 406-1 receives a (previously estimated) time-stamped zonal presence probability vector 412-2 (for tag 2) and applies a temporal transition matrix to that probability vector in order to synchronize the time at which that estimate applies with the timestamp of 412-1. Module 406-1 also applies a spatial relationship matrix to the presence probability vector of 412-2 (via spatial relationship probability values in database 404). The output of 406-1 together with 412-1 then form a statistically independent pair of estimates for the zonal presence probability vector values for tag 1 at the timestamp of 412-1.

In this way, the data from the assisting tag (e.g., tag 2) may be used to infer zonal probabilities associated with tag 1 (via transitioned probabilities 414-1), and together with the output for tag 1 (zonal presence probability vector 412-1) there are now two independent estimates of the zonal presence probability vector associated with each test tag. These estimates 412-1 and 414-1 are provided as inputs to Bayesian network 408-1. The situation for tag 2 is entirely symmetric. Namely, the roles of the test tag and assisting tag are simply reversed.

Bayesian network 408 includes a Bayesian fusion algorithm. The Bayesian fusion algorithm for a pair of tags may be derived from Bayesian analysis. Suppose a system may be in any one of a discrete set of states at any given instant (in the present case, the state is the true zone of the test tag in which the receiver is present). Suppose also that at discrete times, two statistically independent measurements are available, whose values are random variables each drawn from one of a mutually distinct class of distributions, dependent only on the current state of the system (these measurements correspond in our particular case to signal strength measurements from the two different tags).

Statistical independence of the measurements derives from conditioning on the state of the system in the present case under weak assumptions. Let the state that the receiver is present in zone j of tag m at time k be denoted by xₖⱼ^{m}, and denote a single measurement (e.g. signal characteristic) at time k from tag m by yₖ^{m}.

Let the set of all measurements up to and including time k from tag m be Yₖ^{m}={y₁^{m}, y₂^{m}, . . . yₖ^{m}}. The probability that at time k the receiver is in zone j of tag 1 (the test tag) conditioned on having received all of the measurements from both tags up to time k is denoted as (xₖⱼ¹|Yₖ¹, Yₖ²).

Separating out the most recent measurements (time k), the probability may be written as:

(xₖⱼ¹|Yₖ¹,Yₖ²)=(xₖⱼ¹|Yₖ¹,Yₖ²,Yₖ₋₁¹,Yₖ₋₁²). (1)

After application of Bayes' rule and under the assumption of statistical independence, eq. (1) may be expressed as:

$$( {x}_{kj}^{1} \vert {Y}_{k}^{1} , {Y}_{k}^{2} ) = D \cdot \underbrace{( {x}_{kj}^{1} \vert {Y}_{k}^{1} )}_{1} \underbrace{( {x}_{kj}^{1} \vert {Y}_{k}^{2} )}_{2} \underbrace{( {x}_{kj}^{1} \vert {Y}_{k - 1}^{1} , {Y}_{k - 1}^{2} )}_{3} / E \cdot \underbrace{( {x}_{kj}^{1} \vert {Y}_{k - 1}^{1} )}_{4} \underbrace{( {x}_{kj}^{1} \vert {Y}_{k - 1}^{2} )}_{5} \\ where D = ( {y}_{k}^{1} \vert {Y}_{k - 1}^{1} ) ( {y}_{k}^{2} \vert {Y}_{k - 1}^{2} ) \\ and E = ( {y}_{k}^{1} , {y}_{k}^{2} \vert {Y}_{k - 1}^{1} , {Y}_{k - 1}^{2} ) . \qquad ( 2 )$$

In eq. (2), the 1^{st} factor is the probability of the receiver being in zone j of tag 1 conditioned on all the measurements from tag 1. This is the output 412-1 of single tag proximity estimator 402-1 (for tag 1).

The 2^{nd} factor is the probability of the receiver being in zone j of tag 1 conditioned on all the measurements from tag 2. This is obtained from the output 412-2 from single tag proximity estimator 402-2 (for tag 2) using predetermined spatial relationships (from database 404) applied via module 406-1.

The 3^{rd} factor is the probability of being in zone j of tag 1 conditioned an all the previous measurements from both tags. This is the previous output of Bayesian network 408-1, but predicted forwarded to time k using the appropriate zone transition matrix. This process is shown in FIG. 4B. In this figure, previous output 416′ is stored in buffer 402 and applied to fusion block 422. Fusion block 422 includes module 406 (for applying a temporal transition matrix (to propagate the previous output 416′ forward to time k) and Bayesian network 408. FIG. 4B is a portion of a more general estimator 400 for an n number of tags (including test tag 1 and an r=2, n number of assisting tags).

Referring back to FIG. 4A, the 4^{th} factor is the probability of being in zone j of tag 1 conditioned on all the previous measurements from tag 1. It is the previous output 412-1 for tag 1, but predicted forward to time k using the appropriate zone transition matrix of module 406-1.

The 5^{th} factor is the probability of being in zone j of tag 1 conditioned on all the previous measurements from tag 2. It may be obtained from the previous (spatially corrected) output 402-2 for tag 2 (via the spatial relationships applied by module 406-1), but predicted forward to time k using the appropriate zone transition matrix (by module 406-1).

With these interpretations, it may be appreciated that estimator 400 applies a recursive procedure in which present measurements from both tags as well as the previous output 416 of estimator 400 are fused with previous measurements from both tags to provide the required current fused output 416-1 (for tag 1).

The two tag estimation may be extended to more than two tags (i.e., one test tag and two or more assisting tags). The inventors have determined that the probability estimation, for (n−1) assisting tags (numbered from 2 to n), where n is in integer, can be represented as:

$$( {x}_{kj}^{1} \vert {Y}_{k}^{1} , … , {Y}_{k}^{n} ) ∝ ( {x}_{kj}^{1} \vert {Y}_{k - 1}^{1} , … , {Y}_{k - 1}^{n} ) \frac{( {x}_{kj}^{1} \vert {Y}_{k}^{1} )}{( {x}_{kj}^{1} \vert {Y}_{k - 1}^{1} )} {\prod }_{r = 1}^{n} \frac{( {x}_{{km}_{r}}^{r} \vert {Y}_{k}^{r} )}{( {x}_{{km}_{r}}^{r} \vert {Y}_{k - 1}^{r} )} ( {⋂}_{s = 2}^{n} {x}_{{km}_{s}}^{s} \vert {Y}_{kj}^{1} ) \qquad ( 3 )$$

if the spatial relationships between each of the assisting tags with the test tag are coupled. If the spatial relationships between the assisting tags and the test tag are de-coupled, eq. (3) may be represented by eq. (4) as:

$$( {x}_{kj}^{1} \vert {Y}_{k}^{1} , … , {Y}_{k}^{n} ) ∝ ( {x}_{kj}^{1} \vert {Y}_{k - 1}^{1} , … , {Y}_{k - 1}^{n} ) {\prod }_{r = 1}^{n} \frac{( {x}_{kj}^{1} \vert {Y}_{k}^{r} )}{( {x}_{kj}^{1} \vert {Y}_{k - 1}^{r} )} \qquad ( 4 )$$

In operation, it may be desirable to assume that the tags are mutually spatially decoupled, and to use eq. (4), for ease of scalability as the number of assisting tags increases.

Referring again to FIG. 4B, this figure is a functional block diagram of a portion of the zonal proximity estimator 400 for n tags. In general, there are an n number of zonal proximity probabilities 412 (from respective single tag zonal proximity estimator 402) which are provided to fusion block 422. One for the test tag (r=1) and n−1 (i.e., r=2, . . . , n) for the assisting tags which relate to tag 1 by a specified geometry.

The fusion process operates at times k. To further emphasis the dependence of estimator 400 on time, Each zonal presence probability vector 412 may be represented as (x_{τ(r,k),j}^{r}|Y_{τ(r,k)}^{r}). This output 412 represents the output available at time for tag τ at fusion epoch k. Fusion box 422 uses a temporal transition matrix (from module 406 of FIG. 4A) to synchronize the single tag output with the fusion process, to propagate the previous estimate to a current time.

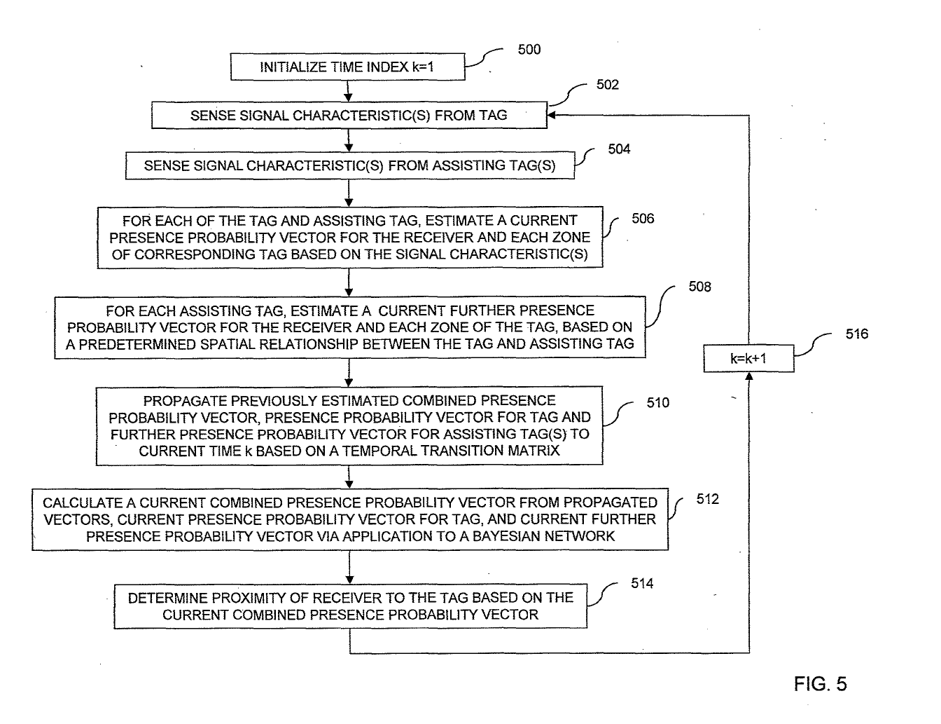

Referring to FIG. 5, a flow chart illustrating a method for estimating a proximity of a receiver to a tag of interest is shown. As discussed above, the method may be performed by client device 102 (FIG. 1), server 104 or a combination thereof.

At step 500, the time index is initialized. At step 502, at least one signal characteristic is sensed from a tag (a test tag) by a receiver. For example, client device 102-1 (FIG. 1) may sense a signal characteristic(s) from first tag 106-1. At step 504, at least one signal characteristic is sensed from at least one assisting tag by the receiver. For example, client device 102-1 (FIG. 1) may sense a signal characteristic(s) from second tag 106-2. In the example, the first tag 106-1 represents a test tag and the second tag 106-2 represents at least one assisting tag that is proximate to the first tag 106-1.

For example, transponders 106-1, 106-2 may broadcast associated BLE signals. Client device 102-1 may receive the BLE signals, decode associated payload data, such as forward error correction (FEC) code, embedded in the BLE signals to obtain a measure of signal quality. As another example, signal strength and/or signal-to-noise ratio may be used as a measure of signal quality. Client device 102-1 then estimates signal characteristics from each sensed tag 106-1, 106-2.

At step 506, for each of the tag (e.g., tag 106-1) and the assisting tag(s) (e.g., tag 106-2), a current presence probability vector is estimated for the receiver and each of one or more zones of the corresponding tag, based on the signal characteristic(s), for example, by single tag proximity estimators 402-1, 402-2 (FIG. 4A). Each current presence probability vector (step 506) represents individual tag probabilities, which do not take into account inter-tag relationships.

At step 508, for each assisting tag (e.g., tag 106-2), a current further presence probability vector is estimated. The further presence probability vector is a proximity for the receiver and each zone of the tag given the presence probability vector estimated for the assisting tag. The further presence probability vector is determined from the presence probability vector of the assisting tag (e.g., zonal presence probability vector 412-2 of tag 2 as shown in FIG. 4A) based on a predetermined spatial relationship between the tag and the assisting tag, for example, by applying a spatial transition matrix (via module 406-1) to the zonal presence probability vector 412-2.

The predetermined relationship may be used to determine the terms in the ratio shown in eq. (4). The single tag output for tag r≠1 is of the form (xₖⱼ^{r}|Yₖ^{r}). For eq. (4) however, the form (xₖⱼ¹|Yₖ^{r}) is needed. To convert the tag output to the appropriate form, a spatial transition matrix is applied to the single tag output as:

$$( {x}_{kj}^{r} \vert {Y}_{k}^{r} ) = {\sum }_{p} \underbrace{( {x}_{ky}^{1} \vert {x}_{kp}^{r} )}_{{spatial}_{{transition}_{matrix}}} ( {x}_{kp}^{r} \vert {Y}_{k}^{r} ) . \qquad ( 5 )$$

At step 510, previously estimated quantities are propagated to current time k based on the temporal transition matrix, for example, via module 406 (FIG. 4A). The previously estimated quantities may include the combined presence probability vector (e.g., output 416′ shown in FIG. 4B), a presence probability vector of the tag (i.e., a previous estimate of zonal presence probability vector 412-1 shown in FIG. 4A), and a further presence probability vector of the assisting tag(s) (i.e., a previous estimate of zonal presence probability vector 412-2 shown in FIG. 4A).

At step 512, a current combined presence probability vector is calculated from the propagated presence probability vectors (step 510), the current presence probability vector of the tag (step 506) and the current further presence probability vector of the assisting tag (step 508) via application to a Bayesian network (e.g., network 408-1 shown in FIG. 4A).

At step 514, the proximity of the receiver to the tag is determined based on the current combined presence probability vector, for example, by server 104 (FIG. 1) or by client device 102-1.

At step 516, the time index is updated and step 516 proceeds to step 502. Steps 502-516 may be repeated for each time index k.

Referring next to FIGS. 6A-6E, top-view diagrams of example multiple tag arrangements in an indoor environment are shown. The arrangements illustrate various spatial relationships between two tags having at least one overlapping zone. In particular, FIG. 6A illustrates a free-space intersection of zones of tags 106-1, 106-2; FIG. 6B illustrates tags 106-1, 1-6-2 arranged opposite to each other on respective shelf units 108-1, 108-2; FIG. 6C illustrates tags 106-1, 1-6-2 arranged adjacent to each other on a single shelf unit 108; FIG. 6D illustrates tags 106-1, 1-6-2 arranged adjacent to each other on a single shelf unit 108-2 in the presence of exclusion area 108-2; and FIG. 6E illustrates two tags 106 having multiple overlapping zones.

Two example methods are described below for obtaining terms pertaining to spatial relationships between zones associated with different tags. In the first example method, several simplified spatial configurations are defined for the purpose of calculating these terms (which are of the form (xₖₘ^{p}|xₖⱼ^{q})). These spatial configurations include free-space (FIG. 6A), opposite (FIG. 6B) and adjacent (FIG. 6C). In the examples shown in FIGS. 6A-6E, the zones are defined as concentric annuli. In general, zones may be deformed annuli about their tag location.

FIG. 6A illustrates a free-space zone intersection. In the free space configuration of FIG. 6A, (xₖ₂¹|xₖ₂²) is the area common (i.e., area_{common}) to zone Z2 of both tags 106, divided by the area of zone Z2 of tag 106-2. FIG. 6B illustrates another configuration where two tags 106 are in an opposite configuration. In this configuration, the exclusion of impenetrable areas 108-1, 108-2 leads to a larger value for (xₖ₂¹|xₖ₂²) than in the free-space configuration (FIG. 6A), because the conditioning region (zone Z2 of tag 106-2) is halved. FIG. 6C illustrates two tags 106 adjacent to each other as well as to impenetrable area 108. In this configuration, the exclusion of impenetrable area 108 leads to the same value for (xₖ₂¹|xₖ₂²) as in the free-space configuration, because the intersection region and the conditioning region (zone Z2 of tag 106-2) are both halved.

The cases above in FIGS. 6B and 6C are only for illustrative purposes. FIG. 6D illustrates an example in which the additional presence of an excluded region 108-2 parallel to region 108-1 further affects the quantity (xₖ₂¹|xₖ₂²), by excluding additional portions of zone Z2 of tag 106-2 and possibly the intersection area (i.e., area_{common}). The probability of proximity in zone Z2 of tag 106-1 conditioned on the proximity in zone Z2 of tag 106-2 may be represented as: (xₖ₂¹|xₖ₂²)=A1/A2, where A1 is area_{common} and A2 is the non-excluded area of zone Z2 of tag 106-2.

Although FIGS. 6A-6D illustrate a single overlapping zone, as shown in FIG. 6E, multiple zones may also overlap. In this example, area_{common} includes zones Z1 of tags 106-1 and 106-2. In general, the probability of proximity in zone 2 of tag 1 conditioned on the proximity in zone 2 of tag 2 may be determined by area_{common} divided by the area of zone Z2 of tag 2. The areas may be determined based on basic geometry.

According to a second exemplary method for obtaining terms pertaining to spatial relationships between zones associated with different tags, a mapped environment may be used to determine terms in (eqs. (3) or (4)) representing the spatial relationships. The map may be considered as a set of Cartesian coordinates associated with its image pixels. Each point in the map lies in a single zone of any chosen tag, outside the range of the tag or in a region excluded from user penetration due to the presence of an obstacle. The quantity (xₖₘ^{p}|xₖⱼ^{q}) may be determined from the number of pixels in the intersection of zone m of tag p with zone j of tag q divided by the total number of pixels in the latter.

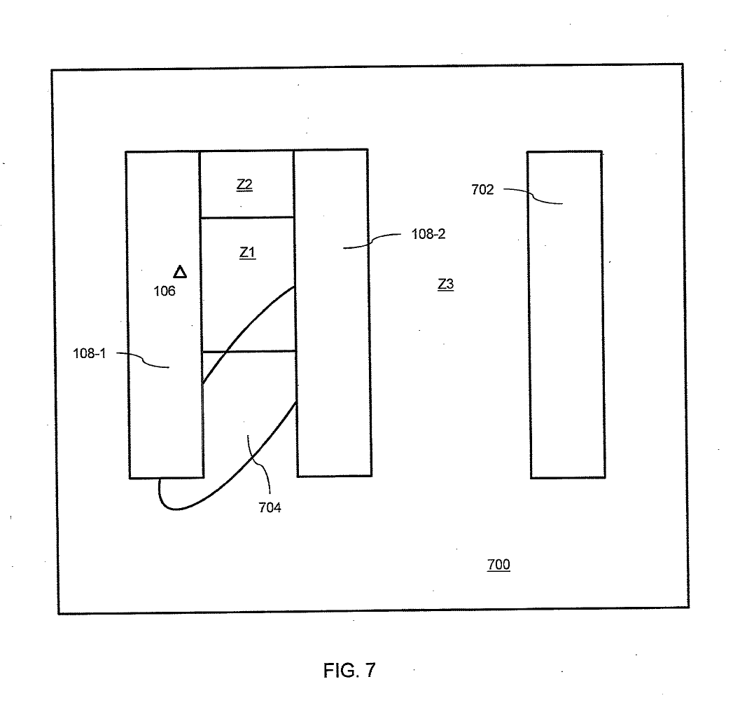

Referring next to FIG. 7, a top-view diagram of tag 106 is shown in mapped environment 700, illustrating estimation of a zonal presence probability vector using a predetermined confidence region. In environment 700, tag 106 may be associated with zones Z1-Z3. Environment 700 may also include an excluded area 702. An estimated position of a client device (not shown) may be represented by a probability density function and may be associated with a confidence region 704.

In an exemplary embodiment, proximity data from the output of a positioning system (e.g., of a client device) in a mapped environment may be used. The system may be provided with an estimated map location together with a confidence value or region 704 or a mechanism to specify the probability of the position being at a given map coordinate. Using the map, an estimated position may be associated with a single zone of each of a number of tags. If a confidence region 704 (set of map coordinates) is available, that region may overlap one or more zones of multiple tags. Each point in the confidence region 704 may be associated with a probability, or it may be assumed that the probability is distributed uniformly among the confidence region 704.

In either case, a zonal presence probability vector for a tag 106 may be calculated by summing the probabilities that lie in both the confidence region 704 and the zone of interest of the tag of interest. If for example, a confidence region 704 is provided as a set of coordinates (pixels) with, for example, a 70% confidence, then the set of pixels within that confidence region would each be associated with a probability of 0.7 divided by the number of pixels in the region. The complement of the confidence region would have its coordinates (pixels) associated with 0.3 divided by its number of pixels.

The probability of each zone may be obtained by integrating the specified probability distribution for each position over the area with a selector function for each zone as:

P(xⱼ¹)=∫P(r)δ(Z¹(r)−j)dr,

where P(R) is the probability distribution for position, r is the map position, Z¹(R) is the zone for tag 1 at position r, the integral is over the 2D space covered by the map and

$$δ = \{ \begin{matrix}1 & if x = 0 \\ 0 & else\end{matrix} .$$

For example, to find the probability for proximity in zone Z3 for tag 1 (tag 106), the number of pixels in zone Z3 may be counted, and weighted with the probability density with which they are associated. The summation over the pixels (weighted by probability) may be expressed as:

$$\begin{matrix}P ( {x}_{Z 3}^{1} ) = {\sum }_{{wholemap}_{i , j}} Probability ( Pixel i , j ) \times \{ \begin{matrix}0 & if pixel i , j ∉ Z 3 \\ 1 & if pixel i , j ∈ Z 3\end{matrix} \\ = {\int }_{map} P ( r ) δ ( {Z}^{1} ( r ) - 3 ) d r .\end{matrix}$$

Thus, the probability of proximity in zone 3 for tag 1 (i.e., the zonal presence probability vector) may be determined by taking into consideration the confidence region 704 associated with the client device's position.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of determining a proximity of a receiver to a tag in a predetermined region, the method comprising the steps of:
sensing, at the receiver, at least one signal characteristic from each of the tag and an assisting tag proximate to the tag, one or more zones being defined for each of the tag and the assisting tag in the predetermined region, each zone representing a respective proximity of the receiver to the tag and the assisting tag;
for each of the tag and the assisting tag, estimating by a processor a presence probability vector for the receiver and each zone of the corresponding tag, based on the sensed at least one signal characteristic;
for the assisting tag, estimating a further presence probability vector for the receiver and each zone of the tag given the presence probability vector estimated for the assisting tag, based on a predetermined spatial relationship between the tag and the assisting tag;
calculating, from the presence probability vector estimated for the tag and the further presence probability vector via a Bayesian network, a combined presence probability vector for the receiver and the corresponding zones of the tag; and
determining the proximity of the receiver to the tag based on the combined presence probability vector.

2. The method of claim 1, wherein the predetermined spatial relationship is based on an intersection region between at least one zone of the tag which overlaps at least one zone of the assisting tag.

3. The method of claim 2, wherein the predetermined spatial relationship is based on a ratio between the intersection region and a total region associated with each zone of the assisting tag.

4. The method of claim 3, wherein the predetermined spatial relationship is based on at least one of a predetermined spatial configuration of each zone or a predetermined map of each zone.

5. The method of claim 1, wherein the calculating of the combined presence probability vector includes:
processing the presence probability vector estimated for the tag and the further presence probability vector according to a recursive Bayesian fusion algorithm.

6. The method of claim 5, wherein the assisting tag includes at least two assisting tags and the recursive Bayesian fusion algorithm is based on the at least two assisting tags being spatially decoupled.

7. The method of claim 5, wherein the assisting tag includes at least two assisting tags and the recursive Bayesian fusion algorithm is based on the at least two assisting tags being spatially coupled.

8. The method of claim 1, wherein the presence probability vector estimated for the tag and the further presence probability vector are each determined for a current state, wherein the calculating of the combined presence probability vector includes:
propagating a previously estimated presence probability vector for the tag of a past state to the current state, to form a first propagated vector;
for the assisting tag, propagating a previously estimated further presence probability vector of the past state to the current state, to form a second propagated vector;
propagating a previously determined combined presence probability vector of the past state to the current state, to form a third propagated vector; and
applying the first propagated vector, the second propagated vector, the third propagated vector, the presence probability vector estimated for the tag and the further presence probability vector to the Bayesian network to form the combined presence probability vector for the current state.

9. The method of claim 8, wherein the first propagated vector, the second propagated vector, and the third propagated vector are determined using a temporal transition matrix which models motion of the receiver.

10. The method of claim 1, wherein the at least one signal characteristic includes at least one of signal strength, signal round-trip time, signal arrival time, signal quality or signal phase.

11. The method of claim 1, wherein the estimating of the presence probability vector includes, for each of the tag and the assisting tag:
modifying the presence probability vector by a predetermined confidence value associated with a probability distribution of a position of the receiver.

12. The method of claim 1, wherein the estimating of the presence probability vector includes, for each of the tag and the assisting tag:
determining a probability distribution of the receiver relative to the corresponding tag based on the respective sensed at least one signal characteristic; and
estimating the presence probability vector between the receiver and the corresponding tag from the probability distribution.

13. A non-transitory computer readable medium including computer-readable programming instructions stored thereon causing a client device to perform functions including:
sensing, at a receiver, at least one signal characteristic from each of a tag and an assisting tag proximate to the tag, one or more zones being defined for each of the tag and the assisting tag in the predetermined region, each zone representing a respective proximity of the client device to the tag and the assisting tag;
for each of the tag and the assisting tag, estimating a presence probability vector for the client device and each zone of the corresponding tag, based on the sensed at least one signal characteristic;
for the assisting tag, estimating a further presence probability vector for the client device and each zone of the tag given the presence probability vector estimated for the assisting tag, based on a predetermined spatial relationship between the tag and the assisting tag;
calculating, from the presence probability vector estimated for the tag and the further presence probability vector via a Bayesian network, a combined presence probability vector for the client device and the corresponding zones of the tag; and
determining the proximity of the client device to the tag based on the combined presence probability vector.

14. The non-transitory computer readable medium of claim 13, wherein the at least one signal characteristic includes at least one of signal strength, signal round-trip time, signal arrival time, signal quality or signal phase.

15. The non-transitory computer readable medium of claim 13, wherein the predetermined spatial relationship is based on a ratio between an intersection region and a total region associated with each zone of the assisting tag, the intersection region being between at least one zone of the tag which overlaps at least one zone of the assisting tag.

16. The non-transitory computer readable medium of claim 15, wherein the predetermined spatial relationship is based on at least one of a predetermined spatial configuration of each zone or a predetermined map of each zone.

17. The non-transitory computer readable medium of claim 13, wherein the Bayesian network is configured to process the presence probability vector estimated for the tag and the further presence probability vector according to a recursive Bayesian fusion algorithm, the recursive Bayesian fusion algorithm using previous estimates for a past state of each of the presence probability vector for the tag, the further presence probability vector for the assisting tag and the combined presence probability vector to determine a current state of the combined presence probability vector.

18. The non-transitory computer readable medium of claim 17, wherein each previous estimate is propagated to the current state using a temporal transition matrix which models motion of the client device.

19. The non-transitory computer readable medium of claim 13, wherein each presence probability vector is modified by a predetermined confidence value associated with a probability distribution of a position of the client device.

20. A server for determining a proximity of a client device to a tag in a predetermined region, the server comprising:
a transceiver for transmitting and receiving data to and from the client device, the transceiver receiving, from the client device, at least one signal characteristic from each of a tag and an assisting tag proximate to the first tag, one or more zones being defined for each of the tag and the assisting tag in the predetermined region, each zone representing a respective proximity of the client device to the tag and the assisting tag;
a database containing data representing a predetermined spatial relationship between the tag and the assisting tag; and
a processor, coupled to the database, and software configured to cause the processor to:
for each of the tag and the assisting tag, estimate a presence probability vector for the client device and each zone of the corresponding tag, based on the sensed at least one signal characteristic;
for the assisting tag, estimate a further presence probability vector for the client device and each zone of the tag given the presence probability vector estimated for the assisting tag, based on the predetermined spatial relationship, stored in the database, between the tag and the assisting tag;
calculate, from the presence probability vector estimated for the tag and the further presence probability vector via a Bayesian network, a combined presence probability vector for the client device and the corresponding zones of the tag;
determine the proximity of the client device to the tag based on the combined presence probability vector; and
transmit, via the transceiver, the determined proximity to the client device.

21. The server of claim 20, wherein the predetermined spatial relationship is based on a ratio between an intersection region and a total region associated with each zone of the assisting tag, the intersection region being between at least one zone of the tag which overlaps at least one zone of the assisting tag.

22. The server of claim 21, wherein the predetermined spatial relationship is based on at least one of a predetermined spatial configuration of each zone or a predetermined map of each zone.

23. The server of claim 20, wherein the Bayesian network is configured to process the presence probability vector estimated for the tag and the further presence probability vector according to a recursive Bayesian fusion algorithm, the recursive Bayesian fusion algorithm using previous estimates for a past state of each of the presence probability vector for the tag, the further presence probability vector for the assisting tag and the combined presence probability vector to determine a current state of the combined presence probability vector.

24. The server of claim 23, wherein the processor is configured to propagate each previous estimate to the current state using a temporal transition matrix which models motion of the client device.

25. The server of claim 20, wherein the processor is configured to modify each presence probability vector by a predetermined confidence value associated with a probability distribution of a position of the client device.
